(19) United States
(12) Patent Application Publication
(10) Pub. No.: US 2013/0002159 A1
(43) Pub. Date: Jan. 3, 2013

(54) CONTROLLING CIRCUIT FOR AN LED DRIVER AND CONTROLLING METHOD THEREOF

(75) Inventors: Shenglun Chen, Hangzhou (CN); Wei Chen, Saratoga, CA (US)

(73) Assignee: HANGZHOU SILERGY SEMICONDUCTOR TECHNOLOGY LTD, Hangzhou (CN)

(21) Appl. No.: 13/344,758

(22) Filed: Jan. 6, 2012

(30) Foreign Application Priority Data
Jan. 10, 2011 (CN) 201110005323.6

(51) Int. Cl. H05B 37/02

(52) U.S. Cl. 315/200 R

(57) ABSTRACT

The present invention relates to a high efficiency light-emitting diode (LED) driver that can include a controller, an LED apparatus, an LED current sensing circuit, and a power switch. The LED current sensing circuit may be used to generate a feedback signal indicative of LED current. The controller may be coupled to the LED current sensing circuit to receive the feedback signal and generate a driving signal. The power switch may be used to operate in periodic on and off conditions to drive the LED apparatus and maintain a driving current of the LED apparatus that is substantially constant.

### RELATED APPLICATIONS

This application claims the benefit of Chinese Patent Application No. CN201110005323.6, filed on Jan. 10, 2011, which is incorporated herein by reference in its entirety.

### FIELD OF THE INVENTION

The present invention generally pertains to electronic circuits, and more particularly to a controlling circuit and method of controlling driver for a light emitting diode (LED).

### BACKGROUND

With rapid development and continuous innovation in the lighting industry, and the growing importance of energy savings and environmental protection, LED lighting rapidly developed as an important lighting technology. However, the luminance of LED lighting (associated with the parameter of luminance intensity) is in direct proportion with the current and forward voltage drop of the LED, and is also varied with temperature. Therefore, it is important to select a constant current generator to drive the LED apparatus, and to maintain ideal luminance. The advantages of LED lighting can only be achieved by optimizing performance of the LED driver.

In view of stability limitations of step down conversion topologies, conventional step down conversion schemes may not be widely used, as compared to conventional step up conversion schemes. However, the step down conversion schemes may take advantage of better match to different loop controlling structures without stability limitation influences. Further, step down conversion schemes may apply hysteresis control with less input voltage range and a faster switching frequency change ratio that meets LED driver requirements.

### SUMMARY

In view of the above-mentioned limitations, particular embodiments may provide a high efficiency light-emitting diode (LED) driver and driving method that can be operated in buck or boost-buck conversion modes by using periphery circuits to solve the problems of relatively complicated circuitry and poor sampling precision.

In one embodiment, an LED driver having a rectifier bridge configured to receive an AC voltage supply and generate first and second input voltages, can include: (i) an LED current sensing circuit coupled to an LED apparatus and configured to generate a feedback signal indicative of a current through the LED apparatus; (ii) a controller coupled to the LED current sensing circuit, the controller being configured to receive the feedback signal and to generate a driving signal; and (iii) a power switch including a controlling terminal configured to receive the driving signal, a first power terminal configured to receive the first input voltage, and a second power terminal coupled to the LED current sensing circuit, where the power switch is configured to operate in periodic on and off conditions to drive the LED apparatus and maintain a driving current of the LED apparatus that is substantially constant.

In one embodiment, a controlling method for such an LED driver can include: (i) converting the AC voltage supply to a DC voltage supply having a first input voltage and a second input voltage; (ii) sensing LED current to generate a feedback signal by using an LED current sensing circuit; (iii) comparing, by a controller, the feedback signal with a first voltage reference to generate a driving signal; and (iv) receiving the driving signal to control operation of a power switch to maintain current of the LED apparatus that is substantially constant.

Embodiments of the present invention can advantageously provide several advantages over conventional approaches. For example, based on input supply voltage and output voltage, the LED driver can be operated as a buck driver or a buck-boost driver for more applications by addition and assistance of periphery circuits. In addition, simplified power switch driving circuitry may allow for achievement of less space and lower cost. LED current regulation precision may also increase due to direct sampling of LED current by a controller. Also, driving power loss can be decreased due to power switch direct driving, and switching power loss may also be decreased by soft switch driving. Further, cost may further be decreased without complex magnetic components, such as transformers or inductors with multiple windings. Other advantages of the present invention will become readily apparent from the detailed description of preferred embodiments below.

### BRIEF DESCRIPTION OF THE DRAWINGS

FIG. 1 is a schematic diagram of a first conventional buck LED driver.

FIG. 2 is a schematic diagram of a second conventional buck LED driver.

FIG. 3A is a schematic diagram of a first example buck LED driver in accordance with embodiments of the present invention.

FIG. 3B is a schematic diagram of a second example buck LED driver in accordance with embodiments of the present invention.

FIG. 3C is a waveform diagram with example waveforms of AC input supply, output voltage, and average input current of the buck LED drivers in accordance with embodiments of the present invention.

FIG. 4A is a schematic diagram of a first example buck-boost LED driver in accordance with embodiments of the present invention.

FIG. 4B is a schematic diagram of a second example buck-boost LED driver in accordance with embodiments of the present invention.

FIG. 4C is a waveform diagram with example waveforms of AC input supply, output voltage, and average input current of the buck-boost LED drivers in accordance with embodiments of the present invention.

FIG. 5A is a schematic diagram of an example power circuit with two power switches connected in series in accordance with embodiments of the present invention.

FIG. 5B is a schematic diagram of an example buck LED driver employing the example power circuit of FIG. 5A.

FIG. 6 is a flow chart of an example LED driving method in accordance with embodiments of the present invention.

### DETAILED DESCRIPTION

Reference will now be made in detail to particular embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set fourth in order to provide a thorough understanding of the present invention. However, it will be readily apparent to one skilled in the art that the present invention may be practiced without these specific details. In other instances, well-known methods, procedures, processes, components, structures, and circuits have not been described in detail so as not to unnecessarily obscure aspects of the present invention.

Some portions of the detailed descriptions which follow are presented in terms of processes, procedures, logic blocks, functional blocks, processing, schematic symbols, and/or other symbolic representations of operations on data streams, signals, or waveforms within a computer, processor, controller, device and/or memory. These descriptions and representations are generally used by those skilled in the data processing arts to effectively convey the substance of their work to others skilled in the art. Usually, though not necessarily, quantities being manipulated take the form of electrical, magnetic, optical, or quantum signals capable of being stored, transferred, combined, compared, and otherwise manipulated in a computer or data processing system. It has proven convenient at times, principally for reasons of common usage, to refer to these signals as bits, waves, waveforms, streams, values, elements, symbols, characters, terms, numbers, or the like.

Furthermore, in the context of this application, the terms “wire,” “wiring,” “line,” “signal,” “conductor,” and “bus” refer to any known structure, construction, arrangement, technique, method and/or process for physically transferring a signal from one point in a circuit to another. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

Embodiments of the present invention can advantageously provide several advantages over conventional approaches. For example, based on input supply voltage and output voltage, the LED driver can be operated as a buck driver or a buck-boost driver for more applications by addition and assistance of periphery circuits. In addition, simplified power switch driving circuitry may allow for achievement of less space and lower cost. LED current regulation precision may also increased due to direct sampling of LED current by a controller. Also, driving power loss can be decreased due to power switch direct driving, and switching power loss may also be decreased by soft switch driving. Further, cost may further be decreased without complex magnetic components, such as transformers or inductors with multiple windings. The invention, in its various aspects, will be explained in greater detail below with regard to exemplary embodiments.

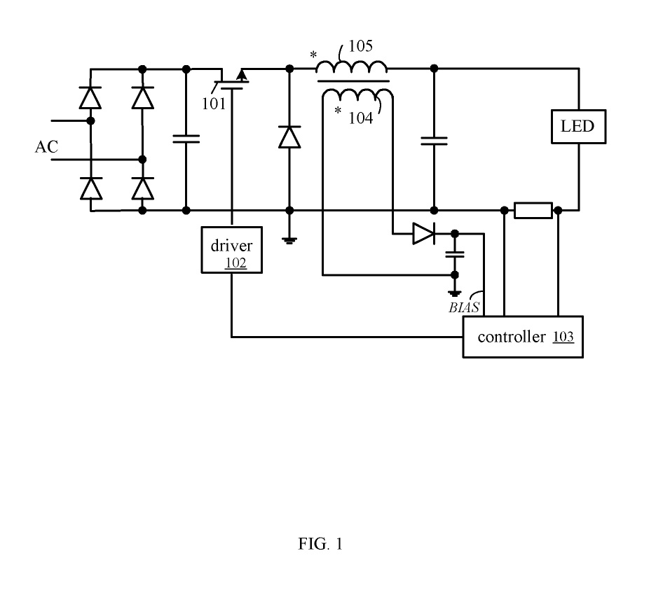

With reference now to FIG. 1, a conventional step down light-emitting diode (LED) driver is shown, and includes a power stage, a controller and a driving circuit. Subsidiary winding 104 can be added to obtain energy from inductor 105 of the power stage to provide supply to controller 103. However, the subsidiary or secondary winding increases magnetic component (e.g., inductor) size, and may violate minimization design requirements. Furthermore, the potential of power switch 101 of the power stage and controller 103 may be different, and as a result a floating driving scheme may be for the driver 102. This can increase complexity, cost, and power loss as compared to direct driving schemes.

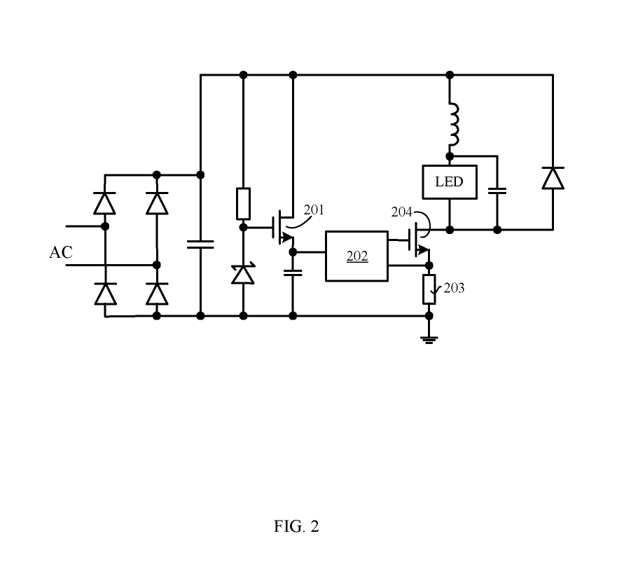

With reference to FIG. 2, another conventional step down LED driver is shown. One difference from the example of FIG. 1 lies in that an individual linear switch 201 is employed to provide supply to controller 202. The power loss of linear switch 201 may vary with the AC input voltage supply. The power loss may thus be relatively large and may not be neglected for higher input voltage applications, and the conversion efficiency may be lower. Also, LED current information can not be obtained in this approach because only the inductor current when power switch 204 is on can be sampled by sensing resistor 203, which leads to reduced precision of LED current regulation. Such reduced precision may be particularly worse when the input voltage range is wider and the variation ratio of the output inductor is higher.

In particular embodiments, the LED driver can be operated as a buck driver or a buck-boost driver for applications by use of corresponding periphery circuits. Examples of buck LED driver configurations in accordance with embodiments will be described in detail below.

In one embodiment, an LED driver having a rectifier bridge configured to receive an AC voltage supply and generate first and second input voltages, can include: (i) an LED current sensing circuit coupled to an LED apparatus and configured to generate a feedback signal indicative of a current through the LED apparatus; (ii) a controller coupled to the LED current sensing circuit, the controller being configured to receive the feedback signal and to generate a driving signal; and (iii) a power switch including a controlling terminal configured to receive the driving signal, a first power terminal configured to receive the first input voltage, and a second power terminal coupled to the LED current sensing circuit, where the power switch is configured to operate in periodic on and off conditions to drive the LED apparatus and maintain a driving current of the LED apparatus that is substantially constant.

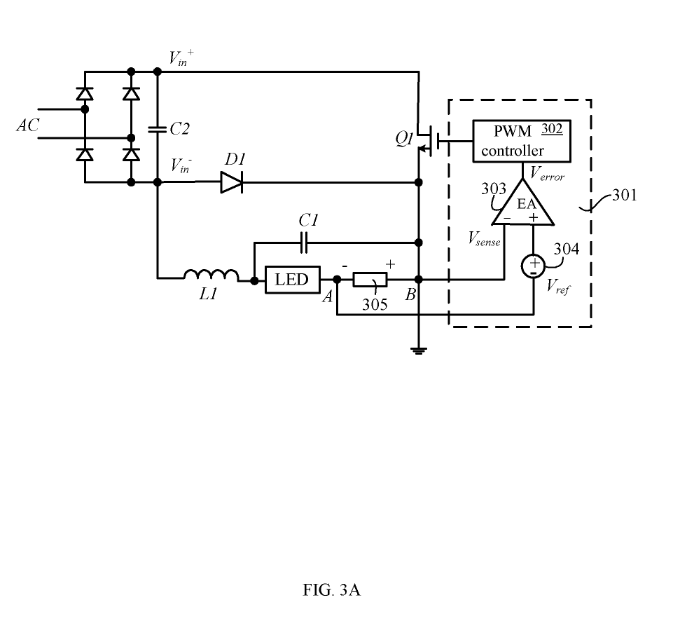

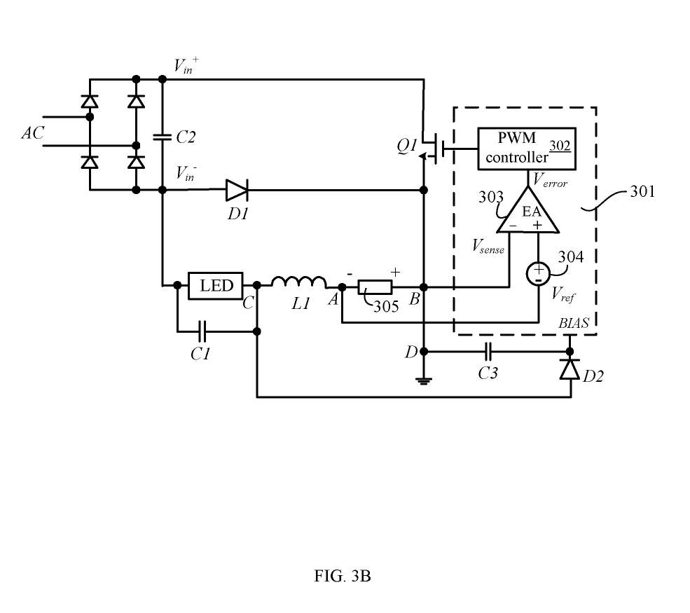

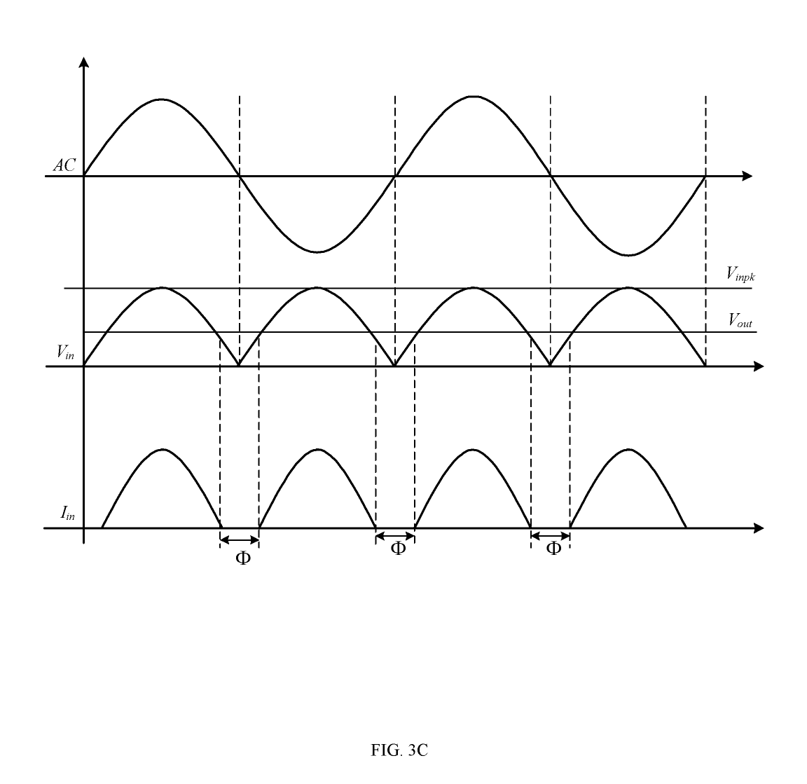

Referring now to FIG. 3A, a first example of a buck LED driver is illustrated, in accordance with embodiments of the present invention. In this example, an AC input voltage supply is converted to a DC voltage supply with a first input voltage Vᵢₙ⁺ and a second input voltage Vᵢₙ⁻, by use of a rectifier bridge and filter capacitor C2.

A buck power stage may be achieved by the combination of power switch Q1, output diode D1, output inductor L1, and output capacitor C1. In some applications, output capacitor C1 can be omitted. In this particular example, power switch Q1 may be an N-type MOSFET (NMOS) transistor with a drain coupled to the first input voltage, and a source connected to ground. Output diode D1 can be connected between the second input voltage and the source of power switch Q1. Output inductor L1 can be connected between the LED apparatus (labeled “LED” in FIG. 3A) and the second input voltage. Output capacitor C1 may be connected between a common node of the LED apparatus and output inductor L1, and the source of power switch Q1, in order to decrease the AC current of the LED apparatus.

LED sensing circuit 305 can be arranged in the output branch that includes the LED apparatus and output inductor L1. LED sensing circuit 305 may be configured to generate a feedback signal to provide accurate LED current information to controller 301.

Controller 301 can include pulse-width modulation (PWM) controller 302, error amplifier (EA) 303, and first voltage reference 304, and may be configured to generate a driving signal in accordance with the LED current information. Terminal A of LED current sensing circuit 305 can be connected to one terminal of first voltage reference 304, while terminal B may be connected to an inverting input of the error amplifier 303. The other terminal of first voltage reference 304 may be connected to a non-inverting terminal of error amplifier 303. The output terminal of error amplifier 303 can be connected to PWM controller 302, the output of which may be connected to a gate of power switch Q1.

Example operation of the buck LED driver example as shown in FIG. 3A will be discussed below. LED current may be sensed accurately by LED current sensing circuit 305, and a feedback signal Vₛₑₙₛₑ may be generated. Error amplifier 303 can receive and compare both feedback signal Vₛₑₙₛₑ and first voltage reference V_{ref} to generate an error signal, Vₑᵣᵣₒᵣ. PWM controller 302 may receive the error signal to generate a driving signal to drive power switch Q1. In this way, the operation of power switch Q1 may be controlled to periodically be in an on or off condition to maintain LED current that is substantially constant. The particular example buck LED driver of FIG. 3A may take advantage of simplified circuitry, more stability, less cost, and less power loss, as compared to conventional approaches.

One skilled in the art may recognize that power switch Q1 can be any suitable type of transistor or transistors, and LED sensing circuit 305 can be a sensing resistor or other type of sensing element or elements. Output inductor L1 can also be connected between the LED apparatus and the second power terminal of the power switch. Output capacitor C1 can also be connected in parallel with the output branch, or other suitable connections.

With reference to FIG. 3B, a second example buck LED driver in accordance with embodiments of the present invention is illustrated. In this example, added relative to the example LED driver of FIG. 3A is a bias supply that includes diode D2 and capacitor C3. One terminal of diode D2 may be connected to common node C of LED apparatus and output inductor L1, while the other terminal of diode D2 may be connected to one terminal of capacitor C3. The other terminal of capacitor C3 can be connected to terminal D as shown. A voltage of a common node of diode D2 and capacitor C3 may be transferred to controller 301 as the bias supply. Herein, output capacitor C1 can also be omitted in some applications.

The buck LED driver shown in FIG. 3B can achieve a number of advantages relative to conventional approaches. For example, LED current sensing precision may be improved to simplify the drive for the power switch, thus improving the conversion precision and decreasing the cost and power loss. Also, the supply of controller 301 may be provided by the bias supply generated from the LED output voltage, which can then be converted through the diode peak rectifier including diode D2 to further decrease power loss and cost.

When the LED output voltage is relatively high, a buck regulator may be utilized for controller 301. Also, when the LED output voltage is relatively low, a subsidiary winding may be utilized to add to output inductor L1 to generate the bias supply for controller 301. Alternatively, a charge pump can be included to generate a higher voltage as the bias supply for controller 301.

With reference to FIG. 3C, waveforms of AC input voltage supply, DC input voltage Vᵢₙ, output voltage Vₒᵤₜ, and average input current Iᵢₙ of example buck LED drivers are shown. Average input current Iᵢₙ with lower harmonic wave can be achieved when the controller employs a high power factor modulation for the buck LED driver examples shown in FIG. 3A and FIG. 3B.

When the difference between output voltage Vₒᵤₜ and peak input voltage Vᵢₙₚₖ is relatively small, dead angle and harmonic of average input current Iᵢₙ may be increased correspondingly. Power factor can be lower for some applications of AC input supply. Buck LED drivers shown in FIG. 3A and FIG. 3B may be applicable to applications where the power factor is not strictly required, or a difference between output voltage Vₒᵤₜ and peak input voltage Vᵢₙₚₖ is relatively large.

As to the buck LED driver, considering that the maximum withstanding voltage of power switch Q1 is the peak input voltage Vᵢₙₚₖ, and the peak current of power switch Q1 is substantially equal to the LED current, reduced power loss, improved regulation efficiency and lower cost can be achieved.

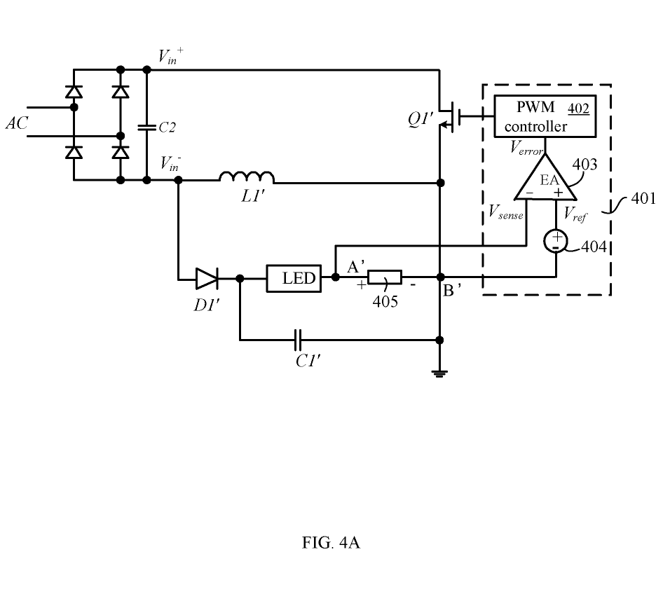

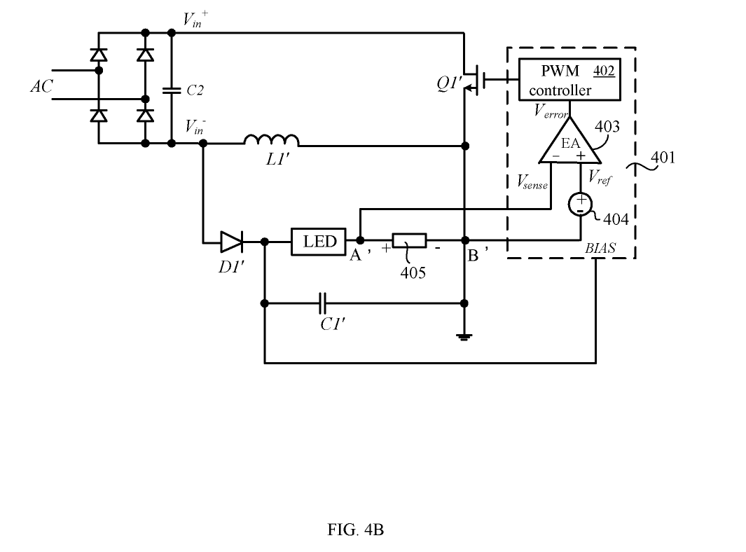

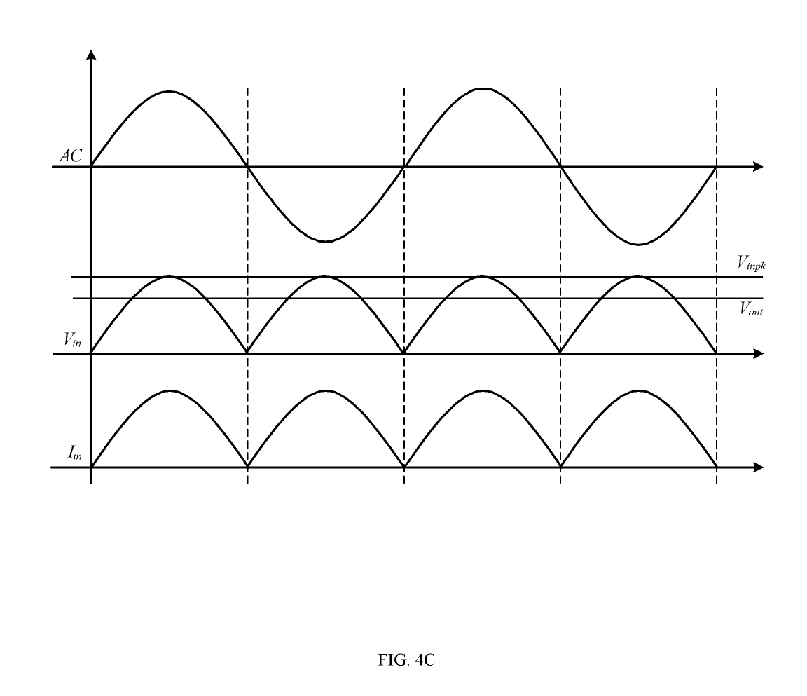

Referring now to FIG. 4A, a first example of a boost-buck LED driver in accordance with embodiments the present invention is illustrated. In this example, AC input voltage supply may be converted to a DC voltage supply Vᵢₙ with a first input voltage Vᵢₙ⁺ and second input voltage Vᵢₙ⁻ by operation of rectifier and filter capacitor C2.

Power switch Q1′, output diode D1′, output inductor L1′, and output capacitor C1′ may form a boost-buck power stage. Taking the example that power switch Q1′ is selected as an N-type MOSFET (NMOS) transistor, a drain of power switch Q1′ can be connected to the first input voltage, and a source may be connected to ground of controller 401. Output inductor L1′ maybe connected between the second input voltage and the source of power switch Q1′. Output diode D1′ can be connected between the LED apparatus (“LED” in FIG. 4A), and the second input voltage. Output capacitor C1′ can connected in parallel with the output branch that includes the LED apparatus and LED current sensing circuit 405.

Accurate LED current information can be provided to controller 401 due to connection of LED current sensing circuit 405 between the LED apparatus and source of power switch Q1′ (at node B′).

Controller 401 can include PWM controller 402, error amplifier (EA) 403, and first voltage reference 404, and may be configured to generate a driving signal in accordance with the LED current information sensed by LED current sensing circuit 405. The B′ terminal of LED current sensing circuit 405 may be connected to one terminal of first voltage reference 404, and the A′ terminal of LED current sensing circuit 405 may be connected to an inverting input terminal of error amplifier 403. The other terminal of first voltage reference 404 may be connected to a non-inverting input terminal of error amplifier 403. The output terminal of error amplifier 403 may be connected to PWM controller 402, an output of which can be connected to a gate of power switch Q1′.

Example operations of the boost-buck LED driver example shown in FIG. 4A may be as follows. LED current can be sensed accurately by LED current sensing circuit 405 to generate a feedback signal, Vₛₑₙₛₑ. An error signal Vₑᵣᵣₒᵣ may be generated by error amplifier 403 in accordance with the feedback signal Vₛₑₙₛₑ and first voltage reference V_{ref}. PWM controller 402 may receive error signal Vₑᵣᵣₒᵣ to generate a corresponding driving signal to drive the power switch Q1′ that may be controlled to operate periodically in an on and off condition in order to maintain an LED current that is substantially constant. In this way, direct driving for power switch Q1′ can take advantage of better stability, lower cost, and simplified circuits, as compared to conventional approaches.

One skilled in the art will recognize that power switch Q1 can be implemented as any suitable type of transistor or transistors, and LED sensing circuit 405 can be a sensing resistor or other suitable sensing element or elements. Output inductor L1 can also be connected between the LED apparatus and second power terminal of power switch Q1′. Output capacitor C1 can also be connected in parallel with the output branch, or in any other suitable connections.

With reference now to FIG. 4B, a second example of a boost-buck LED driver in accordance with embodiments the present invention is illustrated. In this example, a bias supply is added and provided to controller 401, as compared to the example of boost-buck LED driver of FIG. 4A. A voltage of a common node of output diode D1′ and the LED apparatus may also be transferred to controller 401 as the bias supply, as shown.

The boost-buck LED driver example shown in FIG. 4B has many advantages. For example, LED current sensing precision may be improved to simplify the drive for the power switch, thus improving the conversion precision and decreasing the cost and power loss, as compared to conventional approaches. Also, the supply of controller 401 can be provided by the bias supply that is generated from LED output voltage, further decreasing power loss and cost.

When the LED output voltage is relatively high, a buck regulator can be utilized for controller 401. When the LED output voltage is relatively low, a subsidiary or secondary winding can be used to add to output inductor L1 to generate the bias supply for controller 401. Alternatively, a charge pump can be added to generate a higher voltage as the bias supply for controller 401.

With reference to FIG. 4C, example waveforms of AC input voltage supply, DC input voltage Vᵢₙ, output voltage Vₒᵤₜ, and average input current Iᵢₙ of an example boost-buck LED driver are shown. Average input current Iᵢₙ with lower harmonic wave can be achieved when the controller employs a high power factor modulation for the example boost-buck LED drivers shown in FIG. 4A and FIG. 4B.

Due to the non-existence of dead angle for average input current Iᵢₙ, better power factor can be achieved than a corresponding buck LED driver. Also, boost-buck LED drivers can be applicable to any combinations of values of output voltage and input voltage because the output voltage brings lighter influence to power factor. On the same conditions of output voltage level and input voltage level, compared to the example buck LED driver shown in FIG. 3A and FIG. 3B, power switch and output diode may need to withstand sum of peak input voltage and output voltage, which requires a power switch with better withstanding voltage performance. Also, the peak current value of the power switch, diode, and output inductor may be substantially equal to a sum of output current and input current, and the current of the output capacitor is also larger, therefore cost and power loss may be larger in comparison.

For the applications that the withstanding voltage of power switch is not enough, a hybrid power switch including two power switches connected in series can be employed. One such example hybrid power switch will be described below.

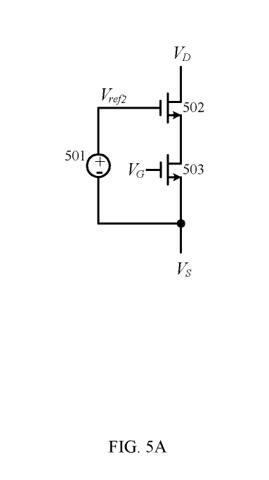

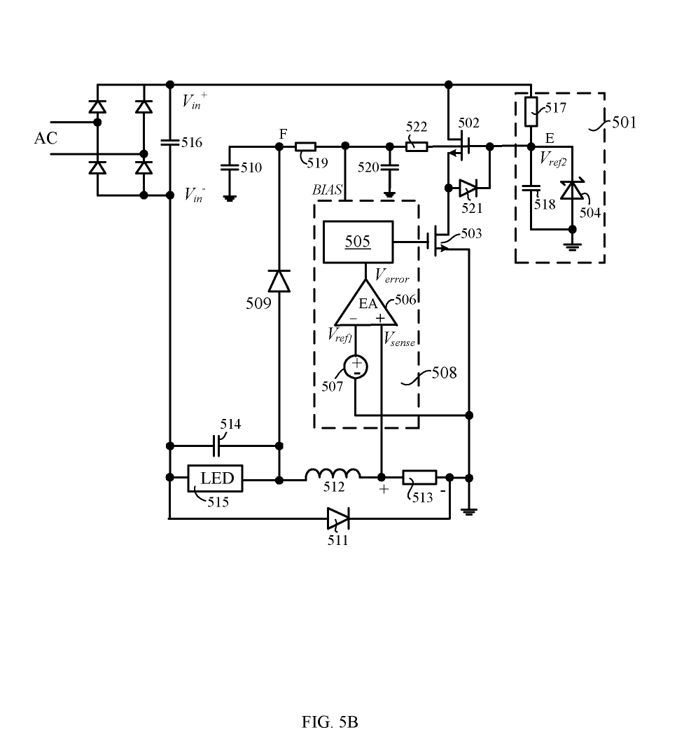

Referring now to FIG. 5A, an example hybrid power switch is shown that includes top power switch 502, bottom power switch 503, and voltage reference 501. In this particular example, a first terminal of top power switch 502 may be connected to voltage V_{D} as the first power terminal of the hybrid power switch. The controlling terminal of top power switch 502 can be connected to one terminal of voltage reference 501. Also, the second terminal of top power switch 502 may be connected to the first terminal of bottom power switch 503. The second terminal of bottom power switch 503 can be connected to the other terminal of voltage reference 501, and to voltage V_{S} as the second power terminal of the hybrid power switch. In addition, the controlling terminal of bottom power switch 503 may be connected to driving voltage V_{G} as the controlling terminal of the hybrid power switch.

When the input voltage is relatively high, a single power switch may not afford the withstanding voltage requirement. To overcome this problem, the hybrid power switch that includes two power switches connected in series may be used. Voltage reference 501 can protect bottom power switch 503 from withstanding higher voltages of about value of voltage reference 501 (e.g., V_{REF2}). Furthermore, the highest withstanding voltage of top power switch 502 can be reduced to a difference between input supply V_{IN} and the value of voltage reference 501, V_{REF2}.

In the example buck LED driver discussed herein, the LED driver employing the hybrid power switch shown in FIG. 5A will be discussed. With reference to FIG. 5B, a schematic diagram of a buck LED driver employing the hybrid power switch shown in FIG. 5A is illustrated. In this example, AC input voltage supply may be converted to a DC voltage supply that includes first input voltage Vᵢₙ⁺ and second input voltage Vᵢₙ⁻ through the operation of rectifier and filter capacitor C2.

Top power switch 502 and bottom power switch 503 can be connected in series, and along with output diode 511, output capacitor 514, and output inductor 512 may form a buck topology power stage. In this example, power switches 502 and 503 can be implemented as NMOS transistors, and a hybrid power switch is implemented by power switches 502 and 503 together with start-up circuit 501. Here, a source of top power switch 502 can be connected to a drain of bottom power switch 503, and a drain of top power switch 502 may be connected to first input voltage Vᵢₙ⁺. Also, the source of bottom power switch 503 may be connected to ground.

Start-up circuit 501 can include zener diode 504, resistor 517, and capacitor 518. One terminal of resistor 517 may be connected to first input voltage Vᵢₙ⁺, while the other terminal of resistor 517 can be connected to one terminal of zener diode 504. The other terminal of zener diode 504 may be connected to the source of bottom power switch 503. A voltage of common node E between resistor 517 and zener diode 504 may be substantially identical to voltage reference V_{ref2} in FIG. 5A. Capacitor 518 can be connected in parallel with zener diode 504, which may help to decrease the resistance of voltage reference V_{ref2}. The withstanding voltage of bottom power switch 503 may be no more than voltage reference V_{ref2}, and the withstanding voltage of top power switch 502 can be the difference between peak input voltage Vᵢₙₚₖ and voltage reference V_{ref2}.

Output diode 511 may be connected between second input voltage Vᵢₙ⁻ and the source of power switch 503. Output inductor 512 and LED apparatus 515 can be connected in series between the second input voltage Vᵢₙ⁻ and the source of power switch 503 to reduce the AC current through LED apparatus 515. Also, output capacitor 514 may be connected in parallel with LED apparatus 515 to further reduce the AC current through LED apparatus 515.

LED current sensing circuit 513 may be coupled in the output branch that includes output inductor 512 and LED apparatus 515. LED current sensing circuit 513 may be connected between output inductor 512 and the source of bottom power switch 503, and also connected to an input terminal of controller 508 to provide accurate LED current information, Vₛₑₙₛₑ.

Controller 508 can include PWM controller 505, error amplifier 506, and voltage reference 507. In this example, one terminal of voltage reference 507 may be connected to the source of power switch 503, while the other terminal of voltage reference 507 may be connected to an inverting input terminal of error amplifier 506 to provide first voltage reference V_{ref1}. The non-inverting input terminal of error amplifier 506 may receive the LED current information Vₛₑₙₛₑ that is sensed by LED current sensing circuit 513, to generate an error signal Vₑᵣᵣₒᵣ at the output terminal. A driving signal may also be generated by PWM controller 505 in accordance with the error signal Vₑᵣᵣₒᵣ.

Diode 521 can be connected between the drain of bottom power switch 503 and common node E to absorb and clamp peak leakage inductance. When powered on, capacitor 518 may be charged by the input voltage through resistor 517 until the voltage of common node E reaches the clamped voltage V_{ref2} of zener diode 504 gradually, and the drain to source voltage of bottom power switch 503 may be clamped to a value of V_{ref2}. The starting current of controller 508 may be generated through voltage reference V_{ref2} of common node E by resistor 522. When the voltage of capacitor 520 reaches a minimum starting voltage, controller 508 may come into operation to generate a driving signal to control bottom power switch 503 to operate in an on and off condition periodically. In this way, sufficient output current can be generated to drive LED apparatus 515.

For example, diode 509 and filter capacitor 510 may form a bias supply provider. One terminal of diode 509 can be connected to a common node of LED apparatus 515 and output inductor 512, while the other terminal of diode 509 maybe connected to one terminal of filter capacitor 510 at the common node F. The other terminal of filter capacitor 510 may be connected to ground as shown. A voltage of common node F may be filtered by resistor 519 and capacitor 520 and transferred to controller 508 as the bias supply, BIAS.

The operation of the example LED driver shown in FIG. 5B may be as follows. LED current maybe accurately sensed by LED current sensing circuit 513, and a feedback signal Vₛₑₙₛₑ is generated. Error amplifier 506 can receive both feedback signal Vₛₑₙₛₑ and voltage reference V_{ref1} to generate an error signal Vₑᵣᵣₒᵣ. A driving signal may be generated by PWM controller 505 in accordance with the received error signal Vₑᵣᵣₒᵣ to control the on and off condition of power switch 503.

When power switch 503 is on, the source of power switch 502 is effectively coupled to ground, the gate of power switch 502 may receive voltage reference V_{ref2}, and then power switch 502 is turned on. When power switch 503 is off, power switch 502 is also correspondingly turned off. The operation of both power switches 502 and 503 can be controlled by the driving signal generated by PWM controller 505.

As to the LED driver shown in FIG. 5B in accordance with particular embodiments, the implementation of direct driving for power switch 503 has advantages of more stability, lower power loss and cost, and a simplified circuit, as compared to conventional approaches. In addition, the withstanding voltage performance may be enhanced by use of hybrid power switch, as discussed.

LED output voltage may be converted to the bias supply for controller 508 by the peak voltage rectifier including diode 509, which decreases both the power loss and cost. When the LED output voltage is relatively high, a buck may be used for controller 508. When the LED output voltage is relatively low, a subsidiary or secondary winding may be used in addition to output inductor L1 to generate the bias supply for the controller 508.

One skilled in the art can recognize that power switches 502 and 503 can be any suitable type of transistor or transistors. In addition, LED current sensing circuit 513 can be implemented by a sensing resistor or other sensing element or elements. Further, the output capacitor may not be necessary, or can be connected to various suitable locations of the output branch.

One particular example of a buck LED driver employing a hybrid power switch has been described in detail. However, and as one skilled in the art will recognize, other types of drivers, such as boost-buck and boost, can also be accommodated in particular embodiments.

Example LED driving methods will be described in accordance with embodiments of the present invention. In one embodiment, a controlling method for such an LED driver can include: (i) converting the AC voltage supply to a DC voltage supply having a first input voltage and a second input voltage; (ii) sensing LED current to generate a feedback signal by using an LED current sensing circuit; (iii) comparing, by a controller, the feedback signal with a first voltage reference to generate a driving signal; and (iv) receiving the driving signal to control operation of a power switch to maintain current of the LED apparatus that is substantially constant.

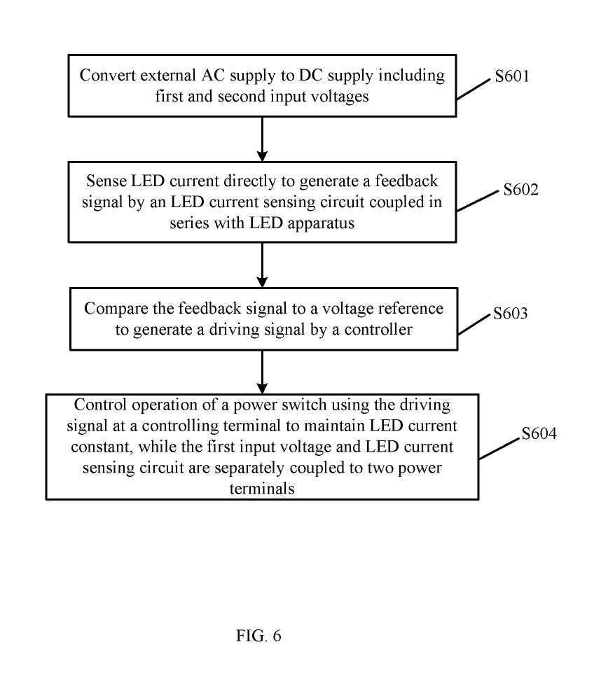

Referring now to FIG. 6, a flow chart of an example high efficiency LED driving method in accordance with embodiments the present invention is shown. Such a method may be used to provide a substantially constant current to an LED apparatus. For example, the method can include, at S601, converting in external AC input voltage supply to a DC voltage supply including first and second input voltages.

At S602, LED current may be sensed directly to generate a feedback signal by using an LED sensing circuit coupled in series with the LED apparatus. At S603, the feedback signal may be compared to a first voltage reference to generate a corresponding driving signal.

At S604, the operation of a power switch may be controlled in accordance with the driving signal in order to maintain an LED current that is substantially constant. The two power terminals may be connected to the first input voltage and the LED current sensing circuit.

Lower harmonic input current can be achieved when a modulation mode of high power factor is employed to generate the driving signal. In addition, suitable operation modes can be selected to regulate output current according to the relationship between input voltage and output voltage.

For example, buck conversion mode may be suitable to applications that do not require a strict power factor, or where the difference between output voltage and peak input voltage is relatively large. In contrast, boost-buck conversion mode may be suitable to applications that require strict power factor, or where cost and/or power loss are not as important.

Further, the LED driving methods shown in FIG. 6 can include where the output voltage of the LED apparatus is converted to a bias supply through a diode peak value rectifier, and made then be transferred to a controller. Therefore, a power supplying method may be implemented that reduces both power loss and cost.

For example, a power switch utilized in the method of FIG. 6 can be a hybrid power switch including a first power switch and a second power switch, as discussed above with reference to FIGS. 5A and 5B. In this example, a first terminal is employed as the first power terminal of the hybrid power switch, a second terminal of the second power switch may be the second power terminal of the hybrid power switch, and a controlling terminal of the second power switch may be employed as the controlling terminal of the hybrid power switch. The second terminal of the first power switch may be connected to a first terminal of second power switch.

Also, a controlling terminal of the first power switch and a second terminal of the second power switch may be connected to two terminals of a voltage reference. Two power switches connected in series can ensure higher input voltage, and the second power switch may not ensure higher voltage under the protection of a voltage reference.

In particular embodiments, a feedback signal indicating accurate LED current information can be obtained by direct sensing to increase the current sensing and regulation precision. Direct driving for power switch may also simplify circuitry and reduce power loss.

The foregoing descriptions of specific embodiments of the present invention have been presented through images and text for purpose of illustration and description of the LED driver controller circuit and method. They are not intended to be exhaustive or to limit the invention to the precise forms disclosed, and obviously many modifications and variations are possible in light of the above teaching, such as the alternatives of the type of switching device, on time sensing circuit of output diode, controlling of switching device and sampling and holding circuit for different applications.

The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A light-emitting diode (LED) driver, the LED driver having a rectifier bridge configured to receive an AC voltage supply and generate first and second input voltages, said LED driver comprising:
a) an LED current sensing circuit coupled to an LED apparatus and configured to generate a feedback signal indicative of a current through said LED apparatus;
b) a controller coupled to said LED current sensing circuit, said controller being configured to receive said feedback signal and to generate a driving signal; and
c) a power switch comprising a controlling terminal configured to receive said driving signal, a first power terminal configured to receive said first input voltage, and a second power terminal coupled to said LED current sensing circuit, wherein said power switch is configured to operate in periodic on and off conditions to drive said LED apparatus and maintain a driving current of said LED apparatus that is substantially constant.

2. The LED driver of claim 1, wherein said power switch comprises a power MOSFET transistor having a gate configured as said controlling terminal, a drain configured as said first power terminal, and a source configured as said second power terminal.

3. The LED driver of claim 1, wherein said controller comprises:
a) an error amplifier configured to receive said feedback signal and a first voltage reference, and to generate a first error signal; and
b) a pulse-width modulation (PWM) controller configured to receive said first error signal, and to generate said driving signal.

4. The LED driver of claim 1, further comprising:
a) a first diode coupled between said second input voltage and said second power terminal of said power switch; and
b) an output inductor coupled between said LED apparatus and said second power terminal of said power switch, said LED apparatus being coupled between said output inductor and said LED current sensing circuit, wherein said LED driver is configured to be operated in a step down mode.

5. The LED driver of claim 4, wherein said LED current sensing circuit comprises a sensing resistor.

6. The LED driver of claim 4, further comprising an output capacitor coupled in parallel with said LED apparatus.

7. The LED driver of claim 4, further comprising:
a) a second diode having a first terminal coupled to a common node of said output inductor and said LED apparatus; and
b) a first filter capacitor having a first terminal coupled to a second terminal of said second diode, said first filter capacitor having a second terminal coupled to ground, wherein a voltage of said common node is configured to be transferred to said controller as a bias supply.

8. The LED driver of claim 1, further comprising:
a) an output diode coupled between said second input voltage and said LED apparatus, wherein said LED apparatus is coupled between said output diode and said LED current sensing circuit, said current sensing circuit being coupled to said second power terminal of said power switch;
b) an output capacitor coupled between a common node of said output diode and said LED apparatus and said second terminal of said power switch; and
c) an output inductor coupled between said second input voltage and said second terminal of said power switch.

9. The LED driver of claim 8, wherein a voltage of said common node of said output diode and said LED apparatus is configured to be transferred to said controller as a bias supply.

10. The LED driver of claim 1, wherein:
a) said power switch is a hybrid power switch comprising a first power switch and a second power switch;
b) a second terminal of said first power switch is coupled to a first terminal of said second power switch, a controlling terminal of said first power switch is coupled to a first terminal of a second voltage reference, and a second terminal of said second power switch is coupled to a second terminal of said second voltage reference; and
c) a first terminal of said first power switch is configured as said first power terminal, a second terminal of said second power switch is configured as said second power terminal, and a controlling terminal of said second power switch is configured as said controlling terminal of said power switch.

11. The LED driver of claim 1, wherein a duty cycle of said driving signal varies with said AC voltage supply to substantially guarantee an average input current that is in proportion with a value of said AC voltage supply.

12. A method of driving a light-emitting diode (LED) by using an AC voltage supply to generate a substantially constant current to drive an LED apparatus, the method comprising:
a) converting said AC voltage supply to a DC voltage supply having a first input voltage and a second input voltage;
b) sensing LED current to generate a feedback signal by using an LED current sensing circuit;
c) comparing, by a controller, said feedback signal with a first voltage reference to generate a driving signal; and
d) receiving said driving signal to control operation of a power switch to maintain current of said LED apparatus that is substantially constant.

13. The method of claim 12, wherein:
a) said power switch is a hybrid power switch comprising a first power switch and a second power switch;
b) a second terminal of said first power switch is coupled to a first terminal of said second power switch, a controlling terminal of said first power switch is coupled to a first terminal of a second voltage reference, and a second terminal of said second power switch is coupled to a second terminal of said second voltage reference; and
c) a first terminal of said first power switch is configured as said first power terminal, a second terminal of said second power switch is configured as said second power terminal, and a controlling terminal of said second power switch is configured as said controlling terminal of said power switch.

14. The method of claim 12, wherein said LED driving method is operated in a step down mode.

15. The method of claim 14, further comprising converting an output voltage of said LED apparatus to a bias supply for said controller.

16. The method of claim 13, wherein said LED driving method is operated in a boost-buck mode.

17. The method of claim 16, further comprising converting an output voltage of said LED apparatus to a bias supply for said controller.

18. The method of claim 17, wherein a duty cycle of said driving signal varies with said AC voltage supply to substantially guarantee an average input current that is in proportion with a value of said AC voltage supply.
